(19) United States
(12) Patent Application Publication
(10) Pub. No.: US 2026/0069983 A1
(43) Pub. Date: Mar. 12, 2026

(54) GAZE ESTIMATION FOR FOCUS ESTIMATION AND CONTENT RATING WITH FOCUS RECOVERY

(71) Applicant: IGT, Las Vegas, NV (US)

(72) Inventors: Soheil Latifi, Brampton (CA); Stefan Keilwert, St. Josef (AT); Gaurav Jariwala, Halifax (CA)

(21) Appl. No.: 18/828,843

(22) Filed: Sep. 9, 2024

(51) Int. Cl. A63F 13/63; A63F 13/213; A63F 13/67; G06F 3/01

(52) U.S. Cl. CPC A63F 13/63; A63F 13/213; A63F 13/67; G06F 3/013

(57) ABSTRACT

Embodiments of the present disclosure are directed to monitoring and rating content of an electronic game based on player eye movement and gaze estimation during game play. According to one embodiment, monitoring content of an electronic game can comprise maintaining a player focus model defining eye movements and changes related to a location of focus of players of the electronic game. Game play information related to the content of the electronic game can be received from a gaming system while being played on the gaming system. Eye movement information for a player of the electronic game can also be received from the gaming system. A focus of the player can be determined based on the player focus model and the received eye movement information and the content of the electronic game can be rated based on the determined focus of the player and the received game play information.

### BACKGROUND

The present disclosure is generally directed to monitoring content of an electronic game and more particularly to monitoring and rating content of an electronic game based on player eye movement and gaze estimation during game play.

Rating the visual designs of games is reliant on market performance of the games. Of course, this method of evaluation is not the most accurate. Nevertheless, when market performance indicates a loss of interest in the game by players, the game is usually replaced or modified to generate new interest. However, identifying the right design elements in games to enhance and improve can be hard. For example, each slot game has many visual elements that can be enhanced. Determining which elements to change is usually intuition based and thus error prone.

### BRIEF SUMMARY

Embodiments of the present disclosure are directed to monitoring and rating content of an electronic game based on player eye movement and gaze estimation during game play. According to one embodiment, a method for monitoring content of an electronic game can comprise maintaining a player focus model defining eye movements and changes related to a location of focus of players of the electronic game. Game play information related to the content of the electronic game can be received from a gaming system while being played on the gaming system. Eye movement information for a player of the electronic game can also be received from the gaming system. A focus of the player can be determined based on the player focus model and the received eye movement information and the content of the electronic game can be rated based on the determined focus of the player and the received game play information.

In some cases, a determination can be made as to whether to modify the content of the electronic game based on the rating of the content of the electronic game. In response to determining to modify the content of the electronic game a modification of the content of the electronic game can be initiated. For example, the rating may indicate a lack of interest in the electronic game by the player and the modification of the content of the electronic game can comprise a modification to draw attention of the player to the electronic game. In such cases, the modification of the content of the electronic game can comprise any one or more of changing a graphic element of the electronic game, changing a color pallet of the electronic game, changing a non-player character of the electronic game, changing a lighting intensity of the electronic game, a generative artificial intelligence modification of the content of the electronic game, and/or others changes. In another example, the rating may indicate a distraction of the player by an element in the electronic game and the modification of the content of the electronic game can comprise a modification to remove the distraction of the player.

According to another embodiment, a system can comprise a processor and a memory coupled with and readable by the processor. The memory can store therein a set of instructions which, when executed by the processor, causes the processor to maintain a player focus model defining eye movements and changes related to a location of focus of players of an electronic game receive, from a gaming system, game play information related to content of the electronic game while played on the gaming system, receive from the gaming system, eye movement information for a player of the electronic game, determine a focus of the player based on the player focus model and the received eye movement information, and determine whether to modify the content of the electronic game based on the determined focus of the player and the received game play information.

In response to determining to modify the content of the electronic game, the instructions can cause the processor to initiate a modification of the content of the electronic game. For example, the modification of the content of the electronic game can comprise any one or more of changing a graphic element of the electronic game, changing a color pallet of the electronic game, changing a non-player character of the electronic game, changing a lighting intensity of the electronic game, a generative artificial intelligence modification of the content of the electronic game, and/or other changes.

According to yet another embodiment, a system can comprise a communication network and a gaming system coupled with the communication network. The gaming system can comprise a sensor, a processor coupled with the sensor, and a memory coupled with and readable by the processor. The memory can store therein a set of instructions which, when executed by the processor, causes the processor to execute an electronic game, collect, via the sensor, eye movement information for a player of the electronic game, and provide, via the communication network, the collected eye movement information for the player of the electronic game and game play information related to content of the electronic game while the game is being played by the player.

The system can further comprise a game content management system coupled with the communication network. The game content management system can comprise a processor and a memory coupled with and readable by the processor. The memory can store therein a set of instructions which, when executed by the processor, causes the processor to maintain a player focus model defining eye movements and changes related to a location of focus of players of the electronic game, receive, from the gaming system, via the communication network, the game play information, receive from the gaming system, the eye movement information for the player of the electronic game, determine a focus of the player based on the player focus model and the received eye movement information, determine whether to modify the content of the electronic game based on the determined focus of the player and the received game play information, and in response to determining to modify the content of the electronic game, initiate a modification of the content of the electronic game.

For example, determining whether to modify the content of the electronic game can further comprise determining a level of interest in the electronic game for the player. In such cases, the modification of the content of the electronic game can comprise a modification to increase the level of interest in the electronic game for the player. In another example, determining whether to modify the content of the electronic game can comprise identifying a distraction of the player by an element in the electronic game. In such cases, the modification of the content of the electronic game can comprise a modification to remove the distraction of the player.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary gaming system according to one embodiment of the present disclosure.

FIG. 3 is a block diagram illustrating additional details of components of an exemplary game content management system according to one embodiment of the present disclosure.

FIG. 4 is a flowchart illustrating an exemplary process for monitoring content of an electronic game according to one embodiment of the present disclosure.

FIG. 5 is a flowchart illustrating an exemplary process for monitoring content of an electronic game according to another embodiment of the present disclosure.

### DETAILED DESCRIPTION

Embodiments of the present disclosure are directed to monitoring and rating content of an electronic game based on player eye movement and gaze estimation during game play. Blinking frequency, pupils’ size, and eye movement correlate with focus and attention. With image segmentation techniques and machine learning, it is possible to monitor the pupil’s movement and detect focus indicators. For example, blinking frequencies can help with understanding the player’s focus span and the visual designs that attract the player’s attention. With this methodology, it is possible to rate the visual designs and how powerful they are for gaining attention of the players and keep them engaged during the gaming process. Embodiments described herein are directed to rating gaming-related content through gaze, and applying techniques for game content adjustment to increase player experience.

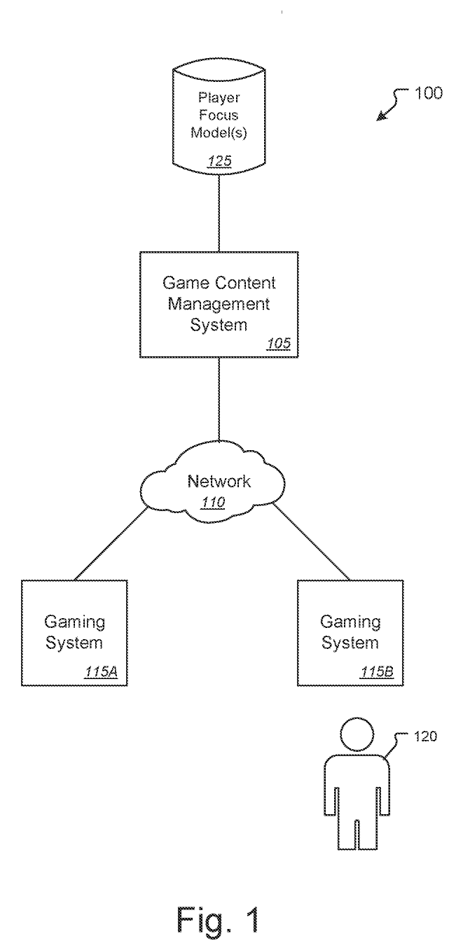

FIG. 1 is a block diagram illustrating an exemplary environment in which embodiments of the present disclosure can be implemented. As illustrated in this example, the environment 100 can comprise a game content management system 105 coupled with a communications network 110. Generally speaking, the game content management system 105 can comprise any one or more servers and/or other computing devices as known in the art. The communications network 110 can comprise any one or more wired and/or wireless, local-area and/or wide-area networks as known in the art including, but not limited to, the Internet. Also coupled with the communications network 110 can be any number of gaming systems 115A-115B. Generally speaking, each gaming system 115 can comprise, for example, any Electronic Gaming Machine (EGM), kiosk, or similar gaming system as may be found in a casino or other gaming venue. The gaming system 115 can each execute any of a variety of electronic games including, but not limited to slots, video slots, video poker, keno, etc.

According to one embodiment, the gaming systems 15A and 115B can be equipped with cameras and/or pupil scanners. Through the cameras, the gaming systems 115A and 115B can collect the pupil movement and size changes of players 120 when playing a game on the gaming system. The collected eye movements data with recorded game transition can be provided by the gaming systems 115A and 115B to the game content management system 105. The game content management system 105 can us this data as training data to train and maintain one or more player focus models 125. Once trained, the player focus model 125 can be used to predict eye movement and pupil contractions. The player focus model 125 can be an image recognition-based model that can be used to identify focus related eye movements of players 120 when playing a game on a gaming system 115B. The degree of eye movement given for a transition and/or symbol in the game can indicate a players focus on the visual element. Similarly, eye movement can be used to identify a visual element responsible for drawing the players attention.

Thus, embodiments can find objects and tokens that keep the players focused and engaged. For example, gaze detection can point out that players usually stare at dragon symbols more, giving a good sense of what to include in the next games. The focus estimation process can also work as a warning generator for the players and manufacturers. For example, when the focus of the player is critically high, the game content management system 305 or a responsible gaming system (not shown here) in communication with the game content management system 105 can issue warnings for the player to take a break. Additionally, or alternatively, when the attention and focus pass a low threshold, the game can be made to show the player highly engaging images and designs so that the player does not end their gaming experience because of low satisfaction.

According to one embodiment, the color pallet of the game can be switched to regain the focus. In some cases, the pallet can be switched to a color blind version if the game content management system 105 detects player is color blind.

According to one embodiment, immersive Non-Player Characters (NPCs) in the game can respond more realistically to the player's gaze and can react to eye contact or look away when the player stares at them. NPCs can react differently or reveal information based on where the player is looking, making the story more engaging.

Additionally, or alternatively, gaze detection can be used to influence the game lighting effects. For example, when a player looks at a specific object, it can trigger a spotlight effect. In addition, or as an alternative to the spotlight effect, the focused area may be rendered sharply in high-res, whereas areas outside of the focus can be rendered with lower resolution, graphic effects and visually dimmed down.

In a game, there are events that, for example, the game-designer wants a player to recognize in order to get the full experience, e.g., a near miss effect0. The game content management system 105 can recognize if a specific visual event presentation is being recognized via gaze tech and can also determine to what degree, e.g., measures time-span between event-pop-up and the player actually looking at it. The game content management system 105 can alter the event presentation, e.g., graphics, animation, timing, sound etc., and measure its player impact to ensure an important event is not overlooked thus providing a feedback-loop of change, measure, learn, and repeat. Additionally, or alternatively, the game content management system 105 can “know” players or player groups and applies best practices, e.g., playstyles, age-groups etc. In some cases, the game content management system 105 can be configured to achieve a performance threshold and continuously vary presentations until the objective is met. According to one embodiment, the game content management system 105 can share “best-practices” or presentation configuration files with various gaming systems and the one with the higher performance criteria can be adopted. Additionally, or alternatively, the game content management system 105 can catalog configurations and best practices according to the underlying event, e.g., near-miss spins, top-jackpot presentation, error-messages etc.

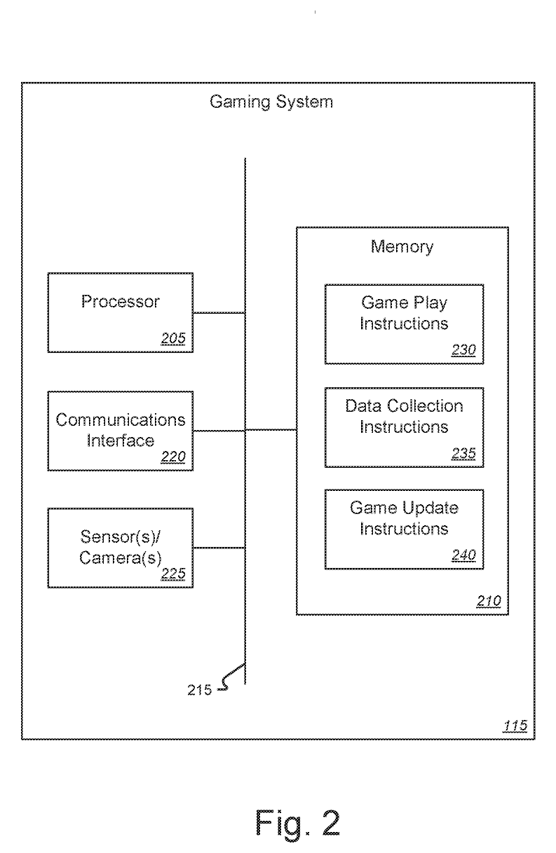

FIG. 2 is a block diagram illustrating additional details of components of an exemplary gaming system according to one embodiment of the present disclosure. As illustrated in this example, a gaming system 115 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 115 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215 and one or more sensors 225. The communication interface(s) 220 can comprise, for example, an Ethernet, Bluetooth, WiFi, cellular, and/or other type of wired and/or wireless communications interface. Via the communication interface(s) 220, the gaming system 115 can communicate with other devices and/or systems through a communications network 110 as described above. The sensors can comprise cameras streaming a view of the players eyes when the player is at a playing position in front of the gaming system 115.

The memory 210 can store therein a set of game play instructions 230 which, when executed by the processor 205, cause the processor 205 to execute an electronic game including, but not limited to slots, video slots, video poker, keno, etc. The memory 210 can also store therein a set of data collection instructions 235 which, when executed by the processor 205, causes the processor 205 to, collect, via the sensor(s) 225, eye movement information for a player of the electronic game, and provide, via the communication interface 220, the collected eye movement information for the player 120 of the electronic game and game play information related to content of the electronic game while the game is being played by the player 120. The memory 210 can also store therein a se of game update instructions 240 which, when executed by the processor 205 can cause the processor 205 to receive, through the communication interface 220, instructions and/or content and update the content of the electronic game accordingly.

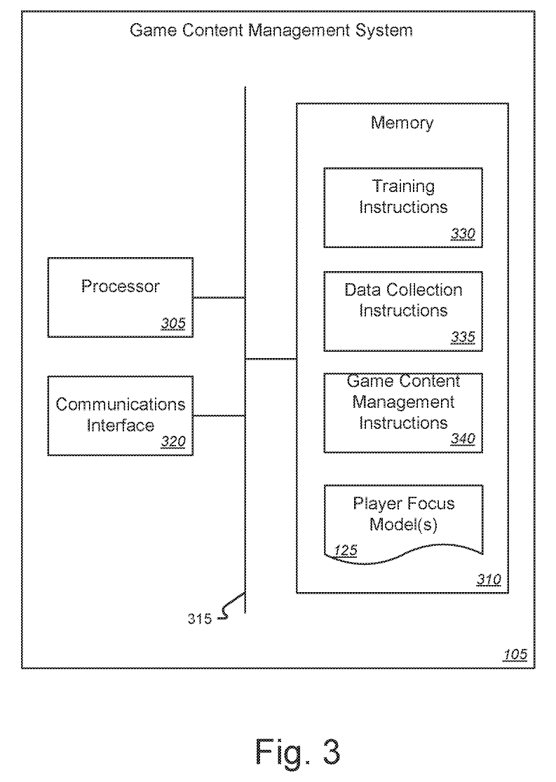

FIG. 3 is a block diagram illustrating additional details of components of an exemplary game content management system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, one or more input/output devices 325, and a display 330. The communication interfaces 320 can comprise, for example, an Ethernet, Bluetooth, WiFi, cellular, and/or other type of wired and/or wireless communications interface.

The memory 310 can store therein a set of training instructions 330 which, when executed by the processor 305, causes the processor to maintain a player focus model 125 defining eye movements and changes related to a location of focus of players of an electronic game. The memory 310 can also store therein a set of data collection instructions 335 which, when executed by the processor 305, can cause the processor 305 to receive, from a gaming system 115, game play information related to content of the electronic game while played on the gaming system and receive from the gaming system 115, eye movement information for a player of the electronic game.

The memory 310 can also store therein a set of game content management instructions 340 which, when executed by the processor 305, can cause the processor 305 to determine a focus of the player based on the player focus model and the received eye movement information, and determine whether to modify the content of the electronic game based on the determined focus of the player and the received game play information. In response to determining to modify the content of the electronic game, the game content management instructions 340 can cause the processor 305 to initiate a modification of the content of the electronic game. For example, the modification of the content of the electronic game can comprise any one or more of changing a graphic element of the electronic game, changing a color pallet of the electronic game, changing a non-player character of the electronic game, changing a lighting intensity of the electronic game, a generative artificial intelligence modification of the content of the electronic game, and/or other changes.

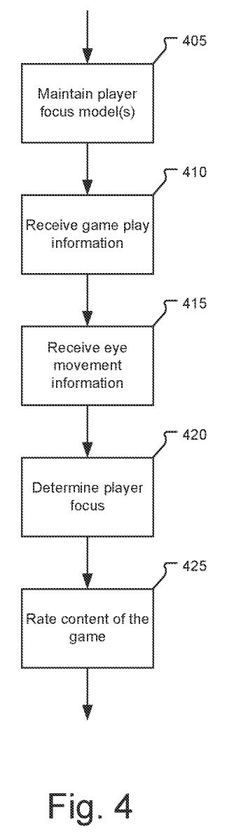

FIG. 4 is a flowchart illustrating an exemplary process for monitoring content of an electronic game according to one embodiment of the present disclosure. As illustrated in this example, monitoring content of an electronic game can comprise maintaining 405 a player focus model 125 defining eye movements and changes related to a location of focus of players of the electronic game. Game play information related to the content of the electronic game can be received 410 from a gaming system 115 while being played on the gaming system 115. Eye movement information for a player 120 of the electronic game can also be received 415 from the gaming system 115. A focus of the player 120 can be determined 420 based on the player focus model 125 and the received eye movement information and the content of the electronic game can be rated 425 based on the determined focus of the player 120 and the received game play information. The rating may indicate, for example, a level of engagement or interest in game, level of attention of the player 120, and/or other measures.

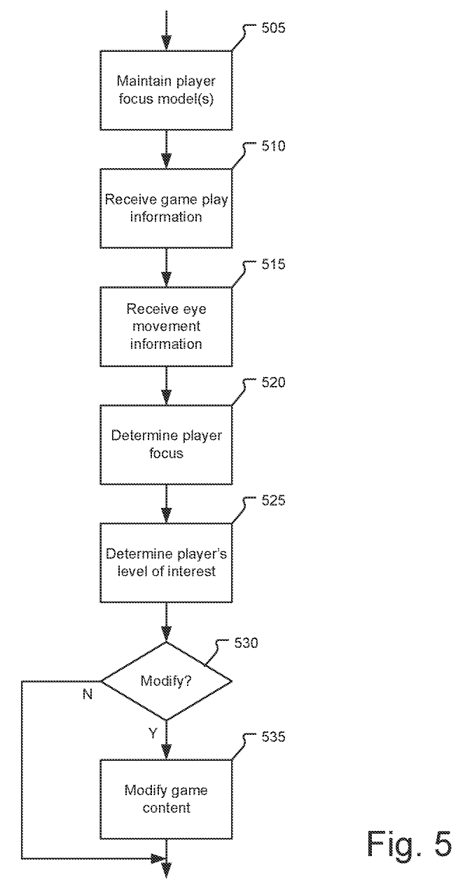

FIG. 5 is a flowchart illustrating an exemplary process for monitoring content of an electronic game according to another embodiment of the present disclosure. As illustrated in this example, monitoring content of an electronic game can comprise maintaining 505 a player focus model 125 defining eye movements and changes related to a location of focus of players of the electronic game. Game play information related to the content of the electronic game can be received 510 from a gaming system 115 while being played on the gaming system 115. Eye movement information for a player 120 of the electronic game can also be received 515 from the gaming system 115. A focus of the player 120 can be determined 520 based on the player focus model 125 and the received eye movement information and a level of interest of the player 120 in the game can be determined 525 based on the determined focus of the player 120 and the received game play information.

A determination 530 can be made as to whether to modify the content of the electronic game based on the level of interest. In response to determining 530 to modify the content of the electronic game a modification of the content of the electronic game can be initiated, e.g., by sending an instruction to the gaming system 115 to change one or more elements, by providing new content elements to the gaming system 115, etc. For example, in response to detecting a lack of interest in the electronic game by the player, the modification of the content of the electronic game can comprise a modification to draw attention of the player to the electronic game. In such cases, the modification of the content of the electronic game can comprise any one or more of changing a graphic element of the electronic game, changing a color pallet of the electronic game, changing a non-player character of the electronic game, changing a lighting intensity of the electronic game, a generative artificial intelligence modification of the content of the electronic game, and/or others changes. In another example, in response to detecting, based on the level of interest, a distraction of the player by an element in the electronic game, the modification of the content of the electronic game can comprise a modification to remove the distraction of the player.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for monitoring content of an electronic game, the method comprising:
maintaining, by a processor of a game content management system, a player focus model defining eye movements and changes related to a location of focus of players of the electronic game;
receiving, by the processor of the game content management system, from a gaming system, game play information related to the content of the electronic game while played on the gaming system;
receiving, by the processor of the game content management system, from the gaming system, eye movement information for a player of the electronic game;
determining, by the processor of the game content management system, a focus of the player based on the player focus model and the received eye movement information; and
rating, by the processor of the game content management system, the content of the electronic game based on the determined focus of the player and the received game play information.

2. The method of claim 1, further comprising:
determining, by the processor of the game content management system, whether to modify the content of the electronic game based on the rating of the content of the electronic game; and
in response to determining to modify the content of the electronic game, initiating, by the processor of the game content management system, a modification of the content of the electronic game.

3. The method of claim 2, wherein the rating indicates a lack of interest in the electronic game by the player and wherein the modification of the content of the electronic game comprises a modification to draw attention of the player to the electronic game.

4. The method of claim 3, wherein the modification of the content of the electronic game comprises changing a graphic element of the electronic game.

5. The method of claim 3, wherein the modification of the content of the electronic game comprises changing a color pallet of the electronic game.

6. The method of claim 3, wherein the modification of the content of the electronic game comprises changing a non-player character of the electronic game.

7. The method of claim 3, wherein the modification of the content of the electronic game comprises changing a lighting intensity of the electronic game.

8. The method of claim 3, wherein the modification of the content of the electronic game comprises a generative artificial intelligence modification of the content of the electronic game.

9. The method of claim 2, wherein the rating indicates a distraction of the player by an element in the electronic game and wherein the modification of the content of the electronic game comprises a modification to remove the distraction of the player.

10. A system comprising:
a processor; and
a memory coupled with and readable by the processor and storing therein a set of instructions which, when executed by the processor, causes the processor to:
maintain a player focus model defining eye movements and changes related to a location of focus of players of an electronic game;
receive, from a gaming system, game play information related to content of the electronic game while played on the gaming system;
receive from the gaming system, eye movement information for a player of the electronic game;
determine a focus of the player based on the player focus model and the received eye movement information;
determine whether to modify the content of the electronic game based on the determined focus of the player and the received game play information; and
in response to determining to modify the content of the electronic game, initiate a modification of the content of the electronic game.

11. The system of claim 10, wherein the modification of the content of the electronic game comprises changing a graphic element of the electronic game.

12. The system of claim 10, wherein the modification of the content of the electronic game comprises changing a color pallet of the electronic game.

13. The system of claim 10, wherein the modification of the content of the electronic game comprises changing a non-player character of the electronic game.

14. The system of claim 10, wherein the modification of the content of the electronic game comprises changing a lighting intensity of the electronic game.

15. The system of claim 10, wherein the modification of the content of the electronic game comprises a generative artificial intelligence modification of the content of the electronic game.

16. A system comprising:
a communication network;
a gaming system coupled with the communication network, the gaming system comprising a sensor, a processor coupled with the sensor, and a memory coupled with and readable by the processor and storing therein a set of instructions which, when executed by the processor, causes the processor to:
execute an electronic game,
collect, via the sensor, eye movement information for a player of the electronic game, and
provide, via the communication network, the collected eye movement information for the player of the electronic game and game play information related to content of the electronic game while the game is being played by the player; and
a game content management system coupled with the communication network, the game content management system comprising a processor and a memory coupled with and readable by the processor and storing therein a set of instructions which, when executed by the processor, causes the processor to:
maintain a player focus model defining eye movements and changes related to a location of focus of players of the electronic game,
receive, from the gaming system, via the communication network, the game play information,
receive from the gaming system, the eye movement information for the player of the electronic game,
determine a focus of the player based on the player focus model and the received eye movement information,
determine whether to modify the content of the electronic game based on the determined focus of the player and the received game play information, and
in response to determining to modify the content of the electronic game, initiate a modification of the content of the electronic game.

17. The system of claim 16, wherein determining whether to modify the content of the electronic game further comprises determining a level of interest in the electronic game for the player.

18. The system of claim 17, wherein the modification of the content of the electronic game comprises a modification to increase the level of interest in the electronic game for the player.

19. The system of claim 16, wherein the determining whether to modify the content of the electronic game further comprises identifying a distraction of the player by an element in the electronic game.

20. The system of claim 19, wherein the modification of the content of the electronic game comprises a modification to remove the distraction of the player.
